(19) United States
(12) Patent Application Publication
(10) Pub. No.: US 2020/0153807 A1
(43) Pub. Date: May 14, 2020

(54) RENDERING APPARATUS IDENTITIES

(71) Applicant: Hewlett-Packard Development Company, L.P., Spring, TX (US)

(72) Inventors: Joshua Serratelli Schiffman, Bristol (GB); Luke T. Mather, Bristol (GB)

(73) Assignee: Hewlett-Packard Development Company, L.P., Spring, TX (US)

(21) Appl. No.: 16/629,981

(22) PCT Filed: Jul. 18, 2017
(86) PCT No.: PCT/US2017/042641

§ 371 Date: Jan. 10, 2020

(51) Int. Cl. H04L 29/06; G06F 21/60; H04L 9/08

(52) U.S. Cl. CPC H04L 63/061; H04L 9/0822; H04L 63/0869; G06F 21/608

(57) ABSTRACT

A method for registering the identity of a rendering apparatus, the method comprising generating a passphrase using a processor of the rendering apparatus, attesting to the validity of the passphrase at user equipment or submitting the passphrase to the user equipment, encrypting a rendering apparatus identity using a cryptographic session key agreed on the basis of the passphrase, and transferring the rendering apparatus identity from the user equipment to a user apparatus

### BACKGROUND

An IT department can manage the identities of rendering apparatus, such as 2D and 3D printers for example, and a pull-print process exists in which a user's print job is held on a server or a user's workstation and released by the user at a printing device. Users manually enrol identities of rendering apparatus onto a workstation.

### BRIEF DESCRIPTION OF THE DRAWINGS

Various features of certain examples will be apparent from the detailed description which follows, taken in conjunction with the accompanying drawings, which together illustrate, by way of example only, a number of features, and wherein:

FIG. 1 is a schematic representation of a method for registering the identity of a rendering apparatus according to an example;

FIG. 2 is a flow chart of a method according to an example; and

FIG. 3 is a schematic representation of a system according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In, for example, a non-enterprise or infrastructure print environment or a traditional IP-based network, users may not have a way to bind the observation of a physical rendering apparatus, such as a 2D or 3D printer, with cryptographic key material used to communicate securely with it. Also, in such an environment, users may not have an automated method for discovering a printer identity and having it available at their printing device (workstation or laptop for example). Collecting a name or IP address of a printer may not be sufficient to ensure that the printer the workstation connects to is the same one that the user found because such identifiers may not be bound to the physical printer.

According to an example, there is provided a method of using a passphrase to establish a shared key that can be deployed over a peer-to-peer or networking transport protocol to transfer an identity and address of a rendering apparatus, such as a printer, to user equipment, such as a mobile device. A user can then securely enrol that render apparatus at their workstation with a minimum of effort and with the assurance that the identity matches the physical printer they observed.

In an example, a password authenticated key exchange (PAKE) can be performed between a rendering apparatus and user equipment to agree a temporary shared key. The key can be used to transport an identity of the rendering apparatus (such as a certificate, or a public key and associated metadata for example) to user equipment (UE). The UE can then transport the identity and enrol it back at the user's workstation. That is, in an example, the UE can configure parameters used for communicating with a rendering apparatus. This can include setting records in an OS, displaying UI elements, and verifying the apparatus identity.

Use of the PAKE authenticates the identity with the physical rendering apparatus, as the user confirms that a passphrase displayed on the apparatus is the same as one they observe on the UE.

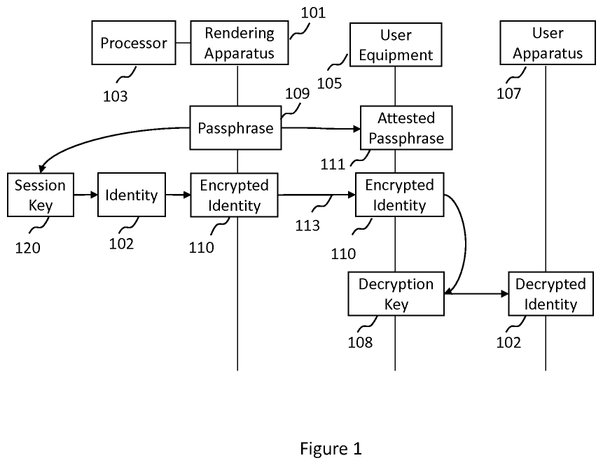

FIG. 1 is a schematic representation of a method for registering the identity of a rendering apparatus according to an example. A passphrase 109 is generated using a processor 103 of a rendering apparatus 101. The passphrase may be an alphanumeric sequence, a sequence of letters or words or other text.

The validity of the passphrase is attested to 111 at user equipment 105 or the passphrase is submitted to user equipment 105. For example, a user may manually input the passphrase at the user equipment 105 or provide a confirmation that a passphrase provided and displayed by the user equipment 105 matches the passphrase 109, which may be displayed on a display of the rendering apparatus 101.

A rendering apparatus identity 102 is encrypted using a cryptographic session key 120 agreed on the basis of the passphrase 109 to provide an encrypted rendering apparatus identity 110. The rendering apparatus identity 110 is transferred from the user equipment to a user apparatus 107, such as a workstation after having been transferred 113 from the rendering apparatus 101 to the user equipment 105. That is, the user can transport the encrypted identity to their workstation. It can be decrypted 108 using the user equipment, which has the shared session key, and the decrypted identity 102 can be transferred from the user equipment 105 to the rendering apparatus 107.

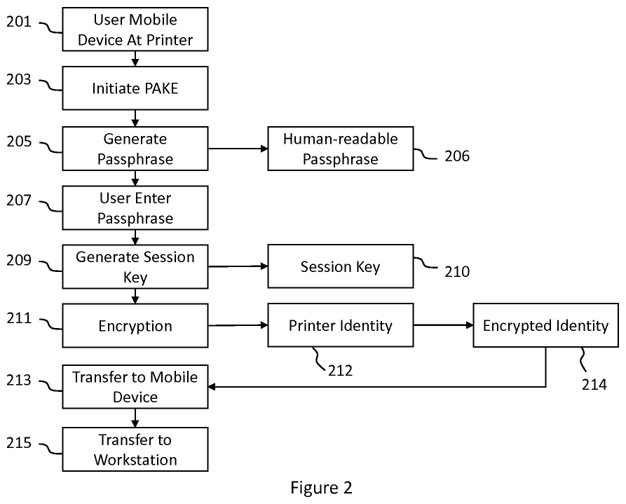

FIG. 2 is a flow chart of a method according to an example. When the user wishes to enrol a printer identity at their workstation, they can perform the following steps.

In block 201, a user carries their mobile device to a printer. The user presses a button on the printer in block 203 or sends a request from their mobile device to the printer to request it to initiate a PAKE in block 203. In block 205, the printer generates a human-readable passphrase 206 and shows the password using an on-device display. In block 207, the user enters the same passphrase (or confirms that a passphrase displayed on its device is the same, depending on the particular PAKE used).

In block 209, a session key 210 is generated on the basis of the passphrase. The key may be generated using a PAKE process, such as SPAKE2 for example). In block 211, the freshly derived session 210 key is used to encrypt the printer's identity material 212 (certificate or public key and metadata for example) to provide an encrypted version of the identity 214 which is transferred to the mobile device in block 213.

An example of the transport process is for the mobile device and printer to exchange random information to produce a session key S. The printer then encrypts the identity I using an authenticated encryption scheme like AES-GCM. This produces an encrypted identity C and an associated integrity tag, T. The printer sends C+T to the mobile device, which then validates T and decrypts C using S.

When the user returns to their workstation, they can initiate the transfer of the identity material 214 from the mobile device to their workstation in block 215. The workstation can then validate the printer's identity (e.g., certificate) against a trust CA certificate and the user can assess other attributes about the printer that are present in the identity. An example would be information about the location and capabilities of the printer. If the user is satisfied with these attributes, they can then instruct the workstation to complete the printer enrollment process. The printer is now authenticated for use from user's workstation. The PAKE can be used over any transport protocol—peer-to-peer or infrastructure.

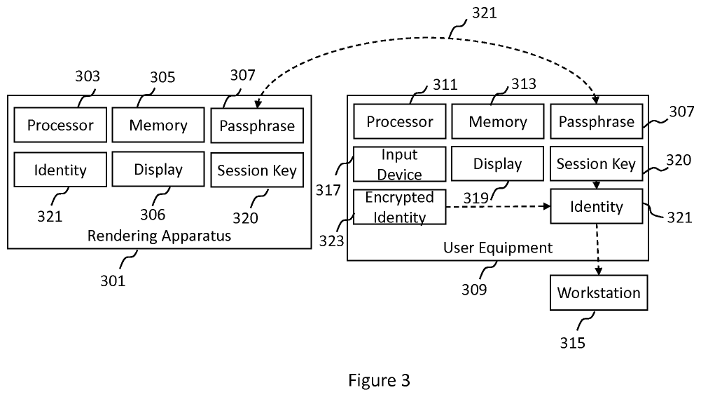

FIG. 3 is a schematic representation of a system according to an example. A rendering apparatus 301, such as a printer for example, comprises a processor 303 and a memory 305. Memory 305 stores data representing a passphrase 307 that has been agreed between the rendering apparatus 301 (or configured by a user or administrator for example) and user equipment 309. Rendering apparatus further comprises a display 306.

User equipment 309 comprises a processor 311 and a memory 313. Memory 313 can store data representing the passphrase 307 that has been agreed between the rendering apparatus 301 and user equipment 309 as noted above. User equipment 309 further comprises an input device 317 and a display 319.

As described above, the validity of the passphrase 307 is attested to at user equipment 309. In an example, this can be by the passphrase 307 being displayed on display 306 of rendering apparatus 301 for a user. The user can then confirm whether the displayed passphrase 307 matches the passphrase that can be displayed using display 319 of user equipment 309. The mutual display of the passphrase can be triggered automatically as the user equipment approaches the vicinity of the apparatus 301 (e.g. user equipment 309 may poll rendering apparatus 301 or vice versa), or may be triggered by the user selecting an appropriate function of the rendering apparatus 301.

In an example, the validity of the passphrase 307 can be attested to at user equipment 309 by submitting the passphrase 307 to the user equipment 309. For example, the rendering apparatus 301 can display the passphrase 307 using display 306. A user can use input device 317 to input the passphrase to the user equipment 309 where the processor 311 can verify that the passphrase matches with one stored in memory 313 for example.

The passphrase, once validated, can be used as part of a PAKE protocol to generate a session key 320 than can be used to encrypt an identity 321 of the rendering apparatus 301 to generate an encrypted rendering apparatus identity 323. User equipment 309 can then be transported to a workstation or device 315 where the encrypted rendering apparatus identity 323 can be decrypted using session key 320 and transferred to the workstation or device 315 to enable the rendering apparatus to be enrolled.

There are several additional approaches for delivering the printer identity to the user. Delivery of a temporary key can be accomplished through visual media such as a QR code on the rendering device's LCD or through a rendering of the key in physical space (e.g., a paper print out or a 3D rendering). The user could then capture this rendering with a camera (e.g., on a mobile phone) and translate the code into a key. The code would also contain information that would be used to contact the apparatus such as the IP address or the name of a WiFi direct network.

As an alternative to the temporary key, the apparatus could generate a one-time use password to access a private WiFi Direct network. This would enable the user's mobile device to contact the apparatus directly and obtain the identity.

The SPAKE2 key exchange algorithm can be implemented on printer and mobile application (Android; iOS) software. The communication between the printer and mobile device can use any transport protocol without security. In an example, the user equipment (mobile device) can use a pre-existing Bluetooth classic pairing with their workstation to transfer the identity and register it with their desktop software.

It is worth noting that the encryption of the identity with the temporary key provides a logical binding between the delivered identity and the physical device that presented the temporary key. This binding is what enables a user to associate an incorporeal identity, such as a cryptographic key, and real world object. While this binding does not prove the identity of the device (this is the responsibility of a certificate verification protocol), it gives the user confidence in the device that bares that identity.

Examples in the present disclosure can be provided as methods, systems or machine-readable instructions. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, user equipment and rendering apparatus) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

With reference to FIG. 3 for example, memory 305, 313 can comprise machine-readable instructions which are executable by processor 303, 311. The instructions can comprise instructions to:

generate a passphrase using a processor of the rendering apparatus;

attest to the validity of the passphrase at user equipment or submitting the passphrase to the user equipment;

encrypt a rendering apparatus identity using a cryptographic session key agreed on the basis of the passphrase; and

transfer the rendering apparatus identity from the user equipment to a user apparatus.

Such machine-readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. A method for registering the identity of a rendering apparatus, the method comprising:
generating a passphrase using a processor of the rendering apparatus;
attesting to the validity of the passphrase at user equipment or submitting the passphrase to the user equipment;
encrypting a rendering apparatus identity using a cryptographic session key agreed on the basis of the passphrase; and
transferring the rendering apparatus identity from the user equipment to a user apparatus.

2. A method as claimed in claim 1, further comprising;
decrypting the encrypted rendering apparatus identity using the cryptographic session key.

3. A method as claimed in claim 2, wherein the encrypted rendering apparatus identity is decrypted at the user equipment.

4. A method as claimed in claim 1, wherein the passphrase is generated as part of a password authenticated key exchange protocol.

5. A method as claimed in claim 1, wherein attesting to the validity of the passphrase at user equipment further comprises:
entering the passphrase to the user equipment; and
comparing the entered passphrase to a pre-defined agreed passphrase stored in a memory of the user equipment.

6. A method as claimed in claim 1 wherein attesting to the validity of the passphrase at user equipment further comprises:
providing a confirmation that the generated passphrase is the same as a pre-defined agreed passphrase stored in a memory of the user equipment.

7. A method as claimed in claim 1, further comprising using the identity of the rendering apparatus to enable secure communication with the user equipment.

8. User equipment comprising a processor to:
attest to the validity of a passphrase or receive an input representing the passphrase;
encrypt a rendering apparatus identity using a cryptographic session key agreed on the basis of the passphrase; and
transfer the rendering apparatus identity from the user equipment to a user apparatus.

9. User equipment as claimed in claim 8, the processor further to:
decrypt the encrypted rendering apparatus identity using the cryptographic session key.

10. User equipment as claimed in claim 8, the processor further to:
compare the entered passphrase to a pre-defined agreed passphrase stored in a memory of the user equipment.

11. User equipment as claimed in claim 8, the processor to:
use the identity of the rendering apparatus to enable secure communication with the user equipment.

12. A non-transitory machine-readable storage medium encoded with instructions executable by a processor of user equipment, the machine-readable storage medium comprising:
instructions to:
attest to the validity of a passphrase or receive an input representing the passphrase;
encrypt a rendering apparatus identity using a cryptographic session key agreed on the basis of the passphrase; and
transfer the rendering apparatus identity from the user equipment to a user apparatus.

13. A non-transitory machine-readable storage medium as claimed in claim 12, further comprising instructions to decrypt the encrypted rendering apparatus identity using the cryptographic session key.

14. A non-transitory machine-readable storage medium as claimed in claim 12, further comprising instructions to compare the entered passphrase to a pre-defined agreed passphrase stored in a memory of the user equipment.

15. A non-transitory machine-readable storage medium as claimed in claim 12, further comprising instructions to use the identity of the rendering apparatus to enable secure communication with the user equipment.
